(19) United States
(12) Patent Application Publication
(10) Pub. No.: US 2024/0057085 A1
(43) Pub. Date: Feb. 15, 2024

(54) PDSCH PROCESSING TIME CONSIDERATION FOR MULTI-CELL PDSCH SCHEDULING WITH A SINGLE DCI

(71) Applicant: APPLE INC., Cupertino, CA (US)

(72) Inventors: Haitong SUN, Cupertino, CA (US); Sigen YE, San Diego, CA (US); Dawei ZHANG, Saratoga, CA (US); Wei ZENG, Saratoga, CA (US); Hong HE, San Jose, CA (US); Chunxuan YE, San Diego, CA (US); Ankit BHAMRI, Bad Nauheim (DE); Jie CUI, San Jose, CA (US)

(73) Assignee: APPLE INC., Cupertino, CA (US)

(21) Appl. No.: 18/365,646

(22) Filed: Aug. 4, 2023

Related U.S. Application Data
(60) Provisional application No. 63/397,094, filed on Aug. 11, 2022.

(51) Int. Cl. H04W 72/20; H04W 72/1273; H04L 5/00; H04L 1/1867

(52) U.S. Cl. CPC H04W 72/20; H04W 72/1273; H04L 5/0051; H04L 1/1887

(57) ABSTRACT

Described are processing time approaches to simultaneous multi-cell PUSCH/PDSCH scheduling with a single DCI (downlink control information) in a wireless communication system. In various approaches, simultaneously scheduling a plurality of physical downlink shared channels (PDSCHs) through a single DCI transmitted via a physical downlink control channel (PDCCH) occurs, wherein each of the plurality of PDSCHs is associated with a respective cell in a plurality of cells. The approaches further include transmitting data to or receiving data to a user equipment (UE) based on the scheduling information, wherein the plurality of PDSCHs occurs no earlier than a time offset following the PDCCH. In other aspects, a hybrid automatic repeat request-acknowledgement (HARQ-ACK) is received via a physical uplink control channel (PUCCH), the HARQ-ACK having been sent by a user equipment (UE) in response to one of the plurality of PDSCHs, wherein the HARQ-ACK is sent no earlier than a time offset following a reference time in one of the plurality of PDSCHs. In other aspects, transmitting data to or receiving data to a user equipment (UE) is based on the scheduling information, wherein the plurality of PDSCHs occurs no earlier than a time offset following the PDCCH, the time offset being configured to permit analog beam switching by a user equipment (UE).

### CROSS REFERENCES

This application claims the benefit of U.S. Provisional Application No. 63/397,094 filed Aug. 11, 2022, titled “PDSCH Processing Time Consideration for Multi-Cell PDSCH Scheduling with a Single DCI,” the content of which is herein incorporated by reference in its entirety.

### BACKGROUND

### Field

Various aspects generally relate to the field of wireless communications.

### SUMMARY

Aspects of the approach described herein include a method by a base station (BS) in a wireless communication network, the method including the following steps. The method includes the step of simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The method further includes transmitting data to or receiving data to a user equipment (UE) based on the scheduling information, wherein the plurality of PDSCHs occurs no earlier than a time offset following the PDCCH.

Aspects of the approach described herein include a base station (BS). The BS includes a radio frequency (RF) transceiver configured to transmit and receive, via at least one antenna. The BS also includes processing circuitry coupled to the RF transceiver. The processing circuitry is configured to cause simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The processing circuitry is further configured to cause transmitting data to or receiving data to a user equipment (UE) based on the scheduling information, wherein the plurality of PDSCHs occurs no earlier than a time offset following the PDCCH.

Aspects of the approach described herein include a method by a base station (BS) in a wireless communication network, the method including the following steps. The method includes the step of simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The method also includes the step receiving a hybrid automatic repeat request-acknowledgement (HARQ-ACK) via a physical uplink control channel (PUCCH), the HARQ-ACK having been sent by a user equipment (UE) in response to one of the plurality of PDSCHs, wherein the HARQ-ACK is sent no earlier than a time offset following a reference time in one of the plurality of PDSCHs.

Aspects of the approach described herein include a base station (BS) in a wireless communications network. The BS includes a radio frequency (RF) transceiver configured to transmit and receive, via at least one antenna, and processing circuitry coupled to the RF transceiver. The processing circuitry is configured to cause simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The processing circuitry is further configured to cause receiving a hybrid automatic repeat request-acknowledgement (HARQ-ACK) via a physical uplink control channel (PUCCH), the HARQ-ACK having been sent by a user equipment (UE) in response to one of the plurality of PDSCHs, wherein the HARQ-ACK is sent no earlier than a time offset following a reference time in one of the plurality of PDSCHs.

Aspects of the approach described herein include a method by a base station (BS) in a wireless communication network, the method including the following steps. The method includes the step of simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The method also includes the step transmitting data to or receiving data to a user equipment (UE) based on the scheduling information, wherein the plurality of PDSCHs occurs no earlier than a time offset following the PDCCH, the time offset being configured to permit analog beam switching by a user equipment (UE).

Aspects of the approach described herein include a base station (BS) in a wireless communications network. The BS includes a radio frequency (RF) transceiver configured to transmit and receive, via at least one antenna, and processing circuitry coupled to the RF transceiver. The processing circuitry is configured to cause simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells. The processing circuitry is further configured to cause transmitting data to or receiving data to a user equipment (UE) based on the scheduling information, wherein the plurality of PDSCHs occurs no earlier than a time offset following the PDCCH, the time offset being configured to permit analog beam switching by a user equipment (UE).

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing for performing simultaneous multi-cell scheduling DCI procedures between a user equipment (UE) and base stations in a wireless communication network, according to some aspects of the disclosure.

FIG. 2 illustrates a block diagram of an example system of an electronic device for performing simultaneous multi-cell scheduling DCI procedures, according to some aspects of the disclosure.

FIGS. 3A-3D highlight various cell scheduling restrictions from the earlier versions of the 3GPP specifications.

FIG. 4 illustrates two processing times on a timeline for simultaneous multi-cell scheduling, according to some aspects of the disclosure.

FIG. 5 illustrates the relevant timing associated with the above six alternatives for processing times, according to some aspects of the disclosure.

FIG. 6A illustrates a flowchart diagram of a method 600 for performing simultaneous multi-cell scheduling with a single DCI, in accordance with aspects of the present disclosure.

FIG. 6B illustrates a flowchart diagram of a method 630 for performing simultaneous multi-cell scheduling with a single DCI, in accordance with aspects of the present disclosure.

FIG. 6C illustrates a flowchart diagram of a method 660 for performing simultaneous multi-cell scheduling with a single DCI, in accordance with aspects of the present disclosure.

FIG. 7 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

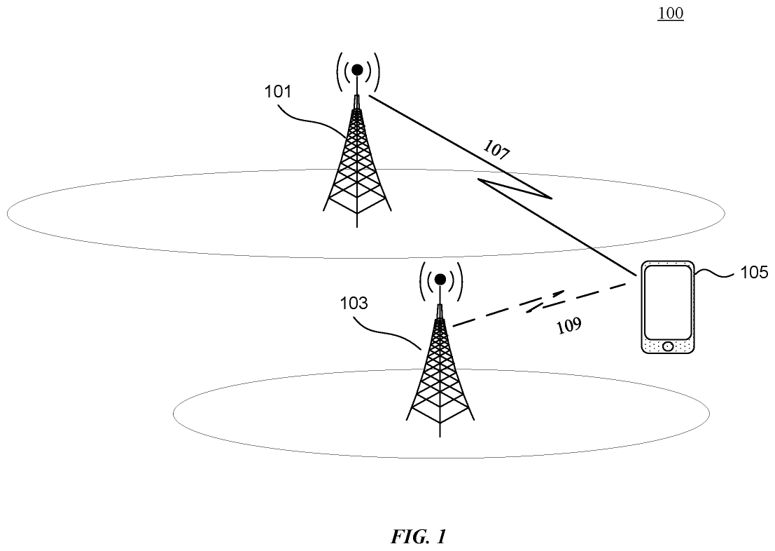

FIG. 1 illustrates an example system implementing mechanisms for performing simultaneous multi-cell scheduling DCI procedures, according to some aspects of the disclosure. Example system 100 is provided for the purpose of illustration only and does not limit the disclosed aspects. System 100 may include, but is not limited to, network nodes (for example, base stations such as eNBs and gNBs) 101 and 103 and electronic device (for example, a UE) 105. Electronic device 105 (hereinafter referred to as UE 105) can be configured to operate based on a wide variety of wireless communication techniques. These techniques can include, but are not limited to, techniques based on 3rd Generation Partnership Project (3GPP) standards. For example, UE 105 can be configured to operate using the 3GPP standards. UE 105 can include, but is not limited to: a wireless communication device, a smart phone, a laptop, a desktop, a tablet, a personal assistant, a monitors, a television, a wearable device, Internet of Things (IoTs), a vehicle's communication device, and the like. Network node 101 (herein referred to as a base station) can include nodes configured to operate based on a wide variety of wireless communication techniques such as, but not limited to, techniques based on 3GPP standards.

According to some aspects, UE 105 and base stations 101 and 103 are configured to implement mechanisms for UE 105 for performing multi-cell scheduling DCI procedures. In some aspects, UE 105 is configured for performing multi-cell scheduling DCI procedures simultaneously. According to some aspects, UE 105 can be connected to and can be communicating with base stations 101 and 103.

According to some aspects, UE 105 can perform various combinations of multi-cell scheduling DCI procedures for communication with base station 101 and other base stations in a group of base stations.

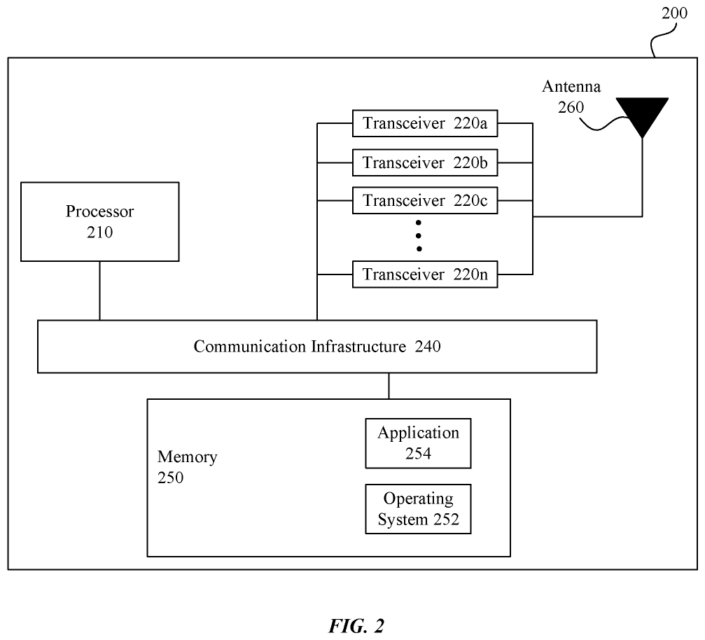

FIG. 2 illustrates a block diagram of an example system 200 of an electronic device implementing simultaneous multi-cell scheduling DCI procedures, according to some aspects of the disclosure. System 200 may be any of the electronic devices (e.g., base stations 101, 103, UE 105) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer. According to some examples, application 254 can be stored in memory 250.

Application 254 can include applications (e.g., user applications) used by wireless system 200 and/or a user of wireless system 200. The applications in application 254 can include applications such as, but not limited to radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus.

In embodiments, processor 210 together with instructions stored in memory 250 performs operations enabling system 200 of system 100 to implement mechanisms for multi-cell scheduling DCI procedures as described herein. Alternatively, in embodiments, processor 210 can be “hard-coded” to implement, or cause to implement, mechanisms for multi-cell scheduling DCI procedures as described herein.

One or more transceivers 220a-220n transmit and receive communications signals that support mechanisms for performing multi-cell scheduling DCI procedures, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, satellite subsystem, a WLAN subsystem, and/or a Bluetooth subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220 n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or other of the 3GPP standards.

In addition, one or more transceivers 220a-220n can include one or more circuits for connecting to and communicating with multiple cells via their respective base stations. Such base station types of networks can include, but are not limited to, wireless communication networks such as 3G/4G/5G networks such as Universal Mobile Telecommunications System (UMTS), and Long-Term Evolution (LTE). For example, one or more transceivers 220a-220n can be configured to operate according to one or more of Rel-15, Rel-16, Rel-17, or other of the 3GPP standards.

According to some aspects, processor 210, alone or in combination with computer instructions stored within memory 250, and/or one or more transceiver 220a-220n, implements multi-cell scheduling DCI procedures, as discussed herein. For example, transceiver 220a can enable connection(s) and communication with, for example, base stations 101 and 103 of FIG. 1). In this example, processor 210 in combination with transceiver 220a and/or transceiver 220b can perform multi-cell scheduling DCI procedures (for example, with base station 101 of FIG. 1 and other base stations not shown in FIG. 1). Although the operations discussed herein are discussed with respect to processor 210, it is noted that processor 210, alone or in combination with computer instructions stored within memory 250, and/or one or more transceiver 220a-220n, can implement these operations.

### PDSCH Processing Time Considerations—Introduction

In previous versions of the 3GPP specifications, the problem of scheduling physical downlink shared channel (PDSCH) across multiple cells has been addressed. For example, in Releases 15 and 16 of the 3GPP specifications, such scheduling was implemented using cross carrier scheduling (CCS) restrictions. Such restrictions ensured simplicity, but included the requirement that a P(S)Cell can be scheduled only by itself. A PCell (primary cell) is the primary cell of the MCG (master cell group). A PSCell (primary secondary cell) is the primary cell of the SCG (secondary cell group). A further restriction in these earlier 3GPP specification releases was that, for each scheduled cell, only one scheduling cell can be RRC (radio resource control) configured. In addition, a further restriction was that, where a cell is configured to be scheduled by another cell, that cell cannot itself be configured to schedule any other cell. Finally, the restrictions in these earlier specifications mandated that neither cross-cell group (CG) nor physical uplink control channel (PUCCH)-group scheduling was supported.

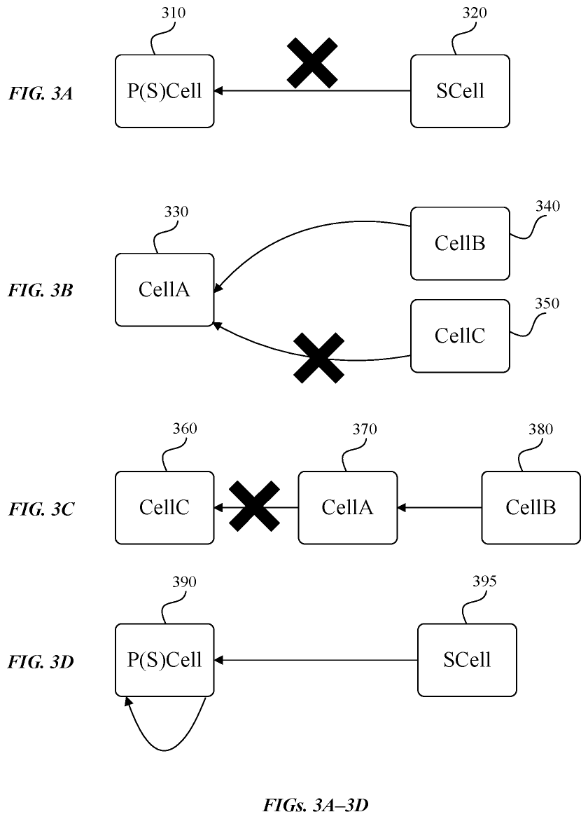

FIGS. 3A-3D highlight various cell scheduling restrictions from the earlier versions of the 3GPP specifications. For example, FIG. 3A illustrates that the P(S)Cell 310 may be scheduled only by itself, i.e., it may not be scheduled by SCell 320. Turning to FIG. 3B, CellB 340 may schedule CellA 330, but CellA 330 may not also be scheduled by another cell, such as CellC 350. FIG. 3C illustrates the additional restriction of the earlier 3GPP specifications that since CellA 370 is scheduled by another cell, CellB 380, it cannot in turn schedule a cell, such as CellC 360.

In Release 17 of the 3GPP specifications, an enhancement was introduced to provide more scheduling flexibility for the primary cell. Specifically, this enhancement allows the P(S)Cell to be scheduled by both the P(S)Cell itself, as well as by one additional cell, e.g., a secondary cell (SCell). In this situation, the SCell that is configured to schedule the P(S)Cell is denoted as a sSCell. FIG. 3D illustrates this enhancement, where P(S)Cell 390 is shown as scheduling itself. In addition, FIG. 3D illustrates that secondary cell SCell 395 may also schedule P(S)Cell 390.

Although the 3GPP Release 17 scheduling enhancements were welcome improvements, there remains an on-going need to provide more scheduling flexibility for multi-cell scenarios. In particular, additional scheduling flexibility is useful for a network (NW) where a P(S)Cell coexists with LTE, and PDCCH monitoring on the P(S)Cell is restricted due to long term evolution (LTE) cell-specific reference signal (CRS). In the existing versions of the 3GPP specifications, including Releases 15, 16 and 17,

a single downlink control information (DCI) can only be used to schedule PDSCH/PUSCH for one cell. In accordance with these existing specifications, the scheduled cell is indicated by the “carrier indicator” field in the DCI. In turn, the mapping of the “carrier indicator” to the actual cell is configured by radio resource control (RRC) via the CrossCarrierSchedulingConfig parameter. This configuration is achieved on a per scheduled cell basis. While the “carrier indicator” is a multi-bit field (e.g., 3-bits) that can be used to identify many different cells, nevertheless only one cell may be indicated at any one time.

Future progress in cellular wireless capabilities requires innovation in terms of support for multi-carrier enhancements, including the simultaneous scheduling thereof. In support of this objective, the disclosure herein provides an approach for a single DCI to schedule channels (physical downlink shared channels (PDSCHs), physical uplink shared channels (PUSCHs)) simultaneously for multiple cells. In formulating this approach, attention is paid to the processing times required to support multi-cell PDSCH scheduling with a single DCI. Specifically, the scheduling must reflect the various processing times of the user equipment (UE) so that the one or more processes may be completed, including the DCI be decoded, the data in the relevant PDSCH(s) be decoded in sufficient time so that the validity of the data may be acknowledged in a HARQ-ACK in the scheduled uplink (PUCCH), and any required beam switching is completed in sufficient time to receive information on the configured beam.

These processing requirements may be decomposed into three separate requirements, as follows. The first processing time requirement is that sufficient time interval (or time offset) be provided such that a UE be able to process the DCI information (from the PDCCH) sufficiently quickly so as to identify the location of its downlink data in the PDSCH signal and be ready to decode its download data. This first processing time interval is referred to as the PDSCH K0 processing time. The second processing time requirement is that sufficient time interval (or time offset) be provided such that the UE be able to decode its downlink data in the PDSCH signal in order to validate the downlink data and thereby prepare the HARQ-ACK for transmission in the PUCCH. This second processing time requirement is referred to as the PDSCH K1 processing time. The third processing time requirement is that sufficient time interval (or time offset) be provided so that processing in support of the required beam switching may occur prior to reception on the desired beam.

Certain embodiments of the first and second processing time requirements may be provided as follows. The K0 processing time (or time offset) may refer to the time interval between the end of the scheduling DCI and the beginning of the scheduled PDSCH. The K1 processing time (or time offset) may refer to the time interval between the end of scheduled PDSCH and the beginning of the PUCCH HARQ-ACK.

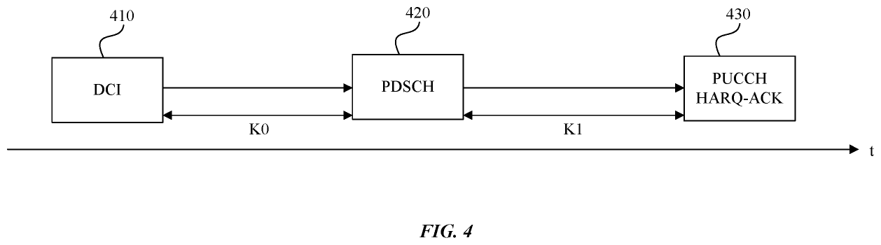

FIG. 4 illustrates these two processing times on a timeline for simultaneous multi-cell scheduling, according to some aspects of the disclosure. In the timeline shown in FIG. 4, three signals are shown, namely DCI 410, PDSCH 420 and PUCCH HARQ-ACK 430. FIG. 4 illustrates the time offsets of interest, including: K0, which is the time offset between the end of scheduling DCI and the beginning of the scheduled PDSCH. FIG. 4 also illustrates K1, which is the time offset between the end of scheduled PDSCH and the beginning of the PUCCH HARQ-ACK. The third processing time requirement associated with PDSCH beam switch time will be discussed further in a later section in this disclosure.

### PDSCH K0 Processing Time—Background

To understand the K0 time offset restriction more fully in a multi-cell PDSCH single-DCI scheduling environment, there are two scenarios that are described below. Without loss of generality, the descriptions below refer to two cells, one being the scheduling cell and the other being the scheduled cell, but the same principles apply to two or more cells being scheduled by a single DCI. The first scenario is where the scheduling and the scheduled cells have the same sub-carrier spacing (SCS). The second scenario is where the scheduling and the scheduled cells have a different SCS. Turning to the first scenario, i.e., for the scheduling with the same SCS (sub-carrier spacing), namely the scheduling cell (PDCCH) and the scheduled cell (PDSCH) have the same SCS. To address the K0 processing time in this first scenario, it is acknowledged that the 3GPP 38.214 specifications contemplate two types of mapping, Type A and Type B, each with associated timing implications.

As noted in the 3GPP 38.214 specifications, in mapping Type A, where PDCCH and PDSCH are in the same slot, the PDCCH has to be contained within the first 3 symbols within this slot. Furthermore, the UE is not expected to receive a PDSCH with mapping type A in a slot, if the PDCCH scheduling the PDSCH was received in the same slot and was not contained within the first three symbols of the slot.

For mapping Type B, the PDSCH cannot start before the PDCCH starts. As noted in the 3GPP specifications, the UE is not expected to receive a PDSCH with mapping type B in a slot, if the first symbol of the PDCCH scheduling the PDSCH was received in a later symbol than the first symbol indicated in the PDSCH time domain resource allocation.

Turning to the second scenario, where the scheduling faces cells with different SCSs, i.e., the scheduling cell (PDCCH) and the scheduled cell (PDSCH) have different SCS. In this second scenario, additional time offset is required. The relevant portions of the 3GPP 38.214 specifications set out the following requirements (where μ is the subcarrier spacing in symbol units):
If the μ_{PDCCH}<μ_{PDSCH}, the UE is expected to receive the scheduled PDSCH, if the first symbol in the PDSCH allocation, including the DM-RS, as defined by the slot offset KO and the start and length indicator SLIV of the scheduling DCI starts no earlier than the first symbol of the slot of the PDSCH reception starting at least N_{pdsch} PDCCH symbols after the end of the PDCCH scheduling the PDSCH, not taking into account the effect of receive timing difference between the scheduling cell and the scheduled cell.
If the μ_{PDCCH}>μ_{PDSCH}, the UE is expected to receive the scheduled PDSCH, if the first symbol in the PDSCH allocation, including the DM-RS, as defined by the slot offset K0 and the start and length indicator SLIV of the scheduling DCI starts no earlier than N_{pdsch} PDCCH symbols after the end of the PDCCH scheduling the PDSCH, not taking into account the effect of receive timing difference between the scheduling cell and the scheduled cell.

TABLE 5.5-1
N_{pdsch} as a function of the subcarrier spacing
of the scheduling PDCCH

| μ_{PDCCH} | N_{pdsch} [symbols] |
|---|---|
| 0 | 4 |
| 1 | 5 |
| 2 | 10 |
| 3 | 14 |
| 5 | 56 |
| 6 | 112 |

### PDSCH K0 Processing Time—Proposed Approaches

With these 3GPP timing requirements in mind, a number of embodiments are proposed for each of the scenarios. In the first proposed approach for the K0 processing time, when a single DCI is allowed to schedule multiple PDSCHs simultaneously in different cells, the processing time requirements are defined that refer to the time offset between scheduling PDCCH and scheduled PDSCH, i.e., K0. For each individual scheduled PDSCH, the K0 processing time requirement is determined independently depending on two factors, specifically: (1) the mapping type, either type A or type B; and (2) the value of the SCS of the scheduled PDSCH compared to the value of the SCS of the scheduling PDCCH. These two factors lead to a possible four combinations.

Two alternative embodiments are described where the scheduled PDSCH and scheduling PDCCH have the same SCS. In the first alternative embodiment, the time offset may be defined to be between the end of the scheduling PDCCH and the beginning of the scheduled PDSCH. In the second alternative embodiment, the time offset may be defined to be between the beginning of the scheduling PDCCH and the beginning of the scheduled PDSCH. In some embodiments, the unit of time offset is in symbols. It is noted that in additional embodiments, an additional time offset may be required between the scheduling PDCCH and the scheduled PDSCH. The additional time offset can be different for different SCS. The additional time offset may be either hard coded in the 3GPP specification, or it may be reported as a UE capability.

Turning now to the second proposed approach for the K0 processing time when a single DCI is allowed to schedule multiple PDSCH simultaneously in different cells, to define the restrictions on time offset between scheduling PDCCH and scheduled PDSCH, i.e., K0. In this second scenario, the scheduled PDSCH and the scheduling PDCCH have different SCS.

If at least for one scheduled PDSCH, we have μ_PDCCH<μ_PDSCH, i.e., the scheduling PDCCH has a smaller SCS compared to the scheduled PDSCH, all the scheduled PDSCH are subject to the time offset restriction assuming μ_PDCCH<μ_PDSCH.

If at least for one scheduled PDSCH, we have μ_PDCCH>μ_PDSCH, i.e., the scheduling PDCCH has a larger SCS compared to the scheduled PDSCH, while no scheduled PDSCH has μ_PDCCH<μ_PDSCH, all the scheduled PDSCH are subject to the time offset restriction assuming μ_PDCCH>μ_PDSCH.

In a third proposed approach for the K0 processing time, when a single DCI is allowed to schedule multiple PDSCH simultaneously in different cells, the restrictions on time offset between scheduling PDCCH and scheduled PDSCH, i.e., K0, for different SCS between PDSCH and PDCCH are defined as follows. In this proposed approach, it is noted that an additional time offset may be required between the scheduling PDCCH and the scheduled PDSCH. The additional time offset can be different for different SCS. The additional time offset may be either hard coded in the 3GPP specification, or it may be reported as a UE capability.

### PDSCH K1 Processing Time—Background

Turning to the 3GPP requirements for the K1 processing time, the time offset restriction is defined as follows in the current 3GPP 38.214 specifications:

T_{proc,1}=(N₁+d_{1,1}+d₂)(2048+144)·κ2^{-μ}·T_{C}+Tₑₛₜ

N_{1,} the minimum time offset N₁ is hardcoded in 3GPP 38.214 specification

d_{1,1} additional relaxation d_{1,1} is determined based on the overlapping condition between PDSCH and PDCCH

TABLE 5.3-1
PDSCH processing time for PDSCH processing capability 1

| | PDSCH decoding time N₁ [symbols] | |
|---|---|---|
| | dmrs-AdditionalPosition = | |
| | ‘pos0’ in | dmrs-AdditionalPosition ≠ |
| | DMRS-DownlinkConfig in | ‘pos0’ in |
| | dmrs-DownlinkForPDSCH- | DMRS-DownlinkConfig |
| | MappingTypeA and dmrs- | in any of |
| | DownlinkForPDSCH- | dmrs-DownlinkForPDSCH- |
| | MappingTypeB if | MappingTypeA, dmrs- |
| | either higher layer parameter is | DownlinkForPDSCH- |
| | configured, and in dmrs- | MappingTypeB, |
| | DownlinkForPDSCH- | dmrs-DownlinkForPDSCH- |
| | MappingTypeA- | MappingTypeA-DCI-1-2, dmrs- |
| | DCI-1-2 and dmrs- | DownlinkForPDSCH- |
| | DownlinkForPDSCH- | MappingTypeB-DCI-1-2, |
| | MappingTypeB-DCI-1-2 | or if none of the |
| | if either higher | higher layer parameters |
| μ | layer parameter is configured | is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

TABLE 5.3-2
PDSCH processing time for PDSCH processing capability 2

| | PDSCH decoding time N₁ [symbols] |
|---|---|
| | dmrs-AdditionalPosition = ‘pos0’ in DMRS-DownlinkConfig |
| | in dmrs-DownlinkForPDSCH-MappingTypeA |
| | and dmrs-DownlinkForPDSCH-MappingTypeB if |
| | either higher layer parameter is configured, and in dmrs- |
| | DownlinkForPDSCH-MappingTypeA-DCI-1-2 and dmrs- |
| | DownlinkForPDSCH-MappingTypeB-DCI-1-2 if either |
| μ | higher layer parameter is configured |
| 0 | 3 |
| 1 | 4.5 |
| 2 | 9 for frequency range 1 |

### PDSCH K1 Processing Time—Proposed Approaches

In the first proposed approach for the K1 processing time, when a single DCI is allowed to schedule multiple PDSCH simultaneously in different cells, a single HARQ-ACK is supported. To determine the reference point for the start of the HARQ turnaround time, i.e. “PDSCH-to-HARQ_feedback timing indicator”, one of the following six alternatives may be used. These six alternatives are: (1) Last symbol of the scheduled PDSCH that ends the latest in time; (2) Last symbol of the scheduled PDSCH that starts the latest in time; (3) Last symbol of the first scheduled PDSCH; (4) Last symbol of the last scheduled PDSCH; (5) Last symbol of the scheduled PDSCH that ends the earliest in time; and (6) Last symbol of the scheduled PDSCH that starts the earliest in time.

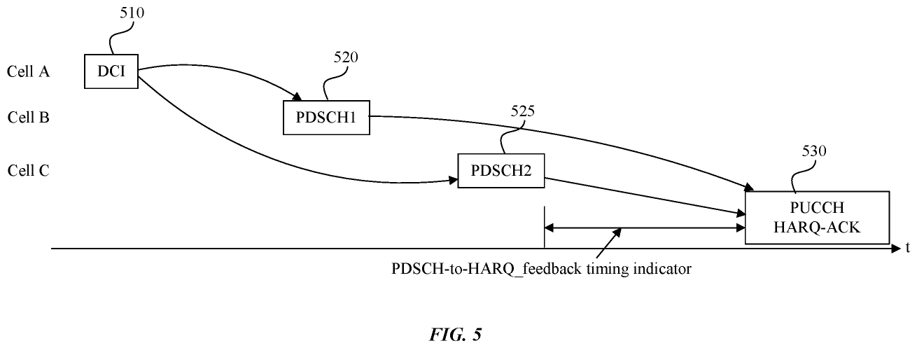

FIG. 5 illustrates the relevant timing associated with the above six alternatives for processing times, according to some aspects of the disclosure. In FIG. 5, Cell A is scheduling Cell B and Cell C. DCI 510 from Cell A schedules PDSCH1 520 of Cell B and PDSCH2 525 of Cell C. The PUCCH HARQ-ACK 530 is the HARQ acknowledgement of the UE. In FIG. 5, the PDSCH-to-HARQ_feedback timing indicator is shown implementing the first alternative, namely last symbol of the scheduled PDSCH that ends the latest in time.

In the second proposed approach for the K1 processing time, when a single DCI is allowed to schedule multiple PDSCH simultaneously in different cells, to determine N_{1,0} for the HARQ-ACK turnaround time, among all the scheduled PDSCHs, there are four alternatives: (1) Use the scheduled PDSCH that gives the largest N_{1,0}; (2) Use the earliest PDSCH; (3) Use the last PDSCH; or (4) Use the PDSCH as the reference PDSCH for HARQ-ACK turn around time (as illustrated in FIG. 5). Note that the earliest/last can be defined either based on the beginning of the PDSCH, or the end of the PDSCH. Also, note that in this specification, the N_{1,0} value is the PDSCH processing time determined based on the additional demodulation reference signal (DMRS) location for 15 kHz subcarrier spacing (SCS).

In the third proposed approach for the K1 processing time, when single DCI is allowed to schedule multiple PDSCH simultaneously in different cells, to determine N₁ for the HARQ-ACK turn around time, among all the scheduled PDSCHs, there are again four alternatives: (1) Use the scheduled PDSCH that gives the largest N₁; (2) Use the earliest PDSCH; (3) Use the last PDSCH; and (4) Use the PDSCH as the reference PDSCH for HARQ-ACK turn around time (as illustrated in FIG. 5). Note that the earliest/last can be defined either based on the beginning of the PDSCH, or the end of the PDSCH. Also, note that in this specification, the N₁ value is the PDSCH processing time determined based on the UE reported PDSCH processing capability, i.e., either capability 1 or capability 2, as a function of the minimum sub carrier spacing (SCS) used for PDSCH, PDCCH and uplink channel that carries the HARQ-ACK.

For the fourth proposed approach for the K1 processing time, when single DCI is allowed to schedule multiple PDSCH simultaneously in different cells, to determine d_{1,1} for the HARQ-ACK turn around time, among all the scheduled PDSCHs, there are again four alternatives: (1) Use the scheduled PDSCH that gives the largest d_{1,1}; (2) Use the earliest PDSCH; (3) Use the last PDSCH; and (4) Use the PDSCH as the reference PDSCH for HARQ-ACK turn around time (as illustrated in FIG. 5). Note that the earliest/last can be defined either based on the beginning of the PDSCH, or the end of the PDSCH. Also, note that in this specification, the d_{1,1} value is the relaxation of the PDSCH processing time determined based on the number of PDSCH symbols and the overlapping condition between PDSCH and PDCCH.

For the fifth proposed approach for the K1 processing time, when single DCI is allowed to schedule multiple PDSCH simultaneously in different cells, to define the restrictions on time offset between scheduled PDSCH and HARQ-ACK, i.e., K1.

Additional time offset can be required between the end of scheduled PDSCH and the beginning of the HARQ-ACK, the time offset unit is in symbols and different for different SCS. This may be either hard coded in the specification, or reported as UE capability.

### PDSCH Beam Switch Time—Background

By way of background, in addition to K0 and K1, for analog beam switching, a minimum time offset is also defined between the end of the scheduling DCI and the beginning of the scheduled PDSCH. The minimum time offset is reported as UE capability in timeDurationForQCL. For cross carrier scheduling with different SCS, when μ_PDCCH<μ_PDSCH, additional time offset relaxation is allowed, as shown below in the current 3GPP 38.214 specifications:

The timeDurationForQCL is determined based on the subcarrier spacing of the scheduled PDSCH. If μ_{PDCCH}<μ_{PDSCH} an additional timing

$$d \frac{{2}^{{μ}_{PDSCH}}}{{2}^{{μ}_{PDCCH}}}$$

is added to the timeDurationForQCL, where d is defined in 5.2.1.4.1a-1, otherwise d is zero;

### PDSCH Beam Switch Time—Embodiments

For the first proposed approach for the beam switching processing time, when single DCI is allowed to schedule multiple PDSCH simultaneously in different cells, to determine the minimum time offset for beam switching, i.e., timeDurationForQCL. For each individual scheduled PDSCH, the minimum time offset for beam switching is determined independently depends on SCS of the scheduling PDCCH, and SCS of the scheduled PDSCH. For the second proposed approach for the beam switching processing time, when single

DCI is allowed to schedule multiple PDSCH simultaneously in different cells, to determine time offset relaxation d for beam switching, among all the scheduled PDSCHs, there are two alternatives: (1) use each PDSCH individually; and (2) use the scheduled PDSCH that gives the largest d. Note that in this specification, time offset relaxation d is 8 PDCCH symbols if μ_{PDCCH} is 0, 8 PDCCH symbols if μ_{PDCCH} is 1, 14 PDCCH symbols if μ_{PDCCH} is 2, zero otherwise.

For the third proposed approach for the beam switching processing time, when single DCI is allowed to schedule multiple PDSCH simultaneously in different cells, additional time offset can be required for beam switching, the time offset unit is in symbols and different for different SCS. This may be either hard coded in the specification, or reported as UE capability.

### Summary of Methods for Processing Timing with Simultaneous Multi-Cell Scheduling DCI

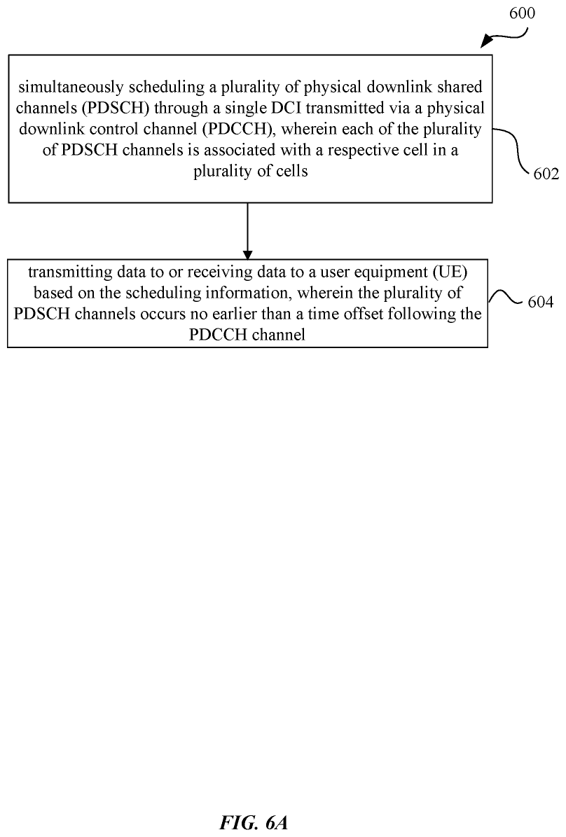

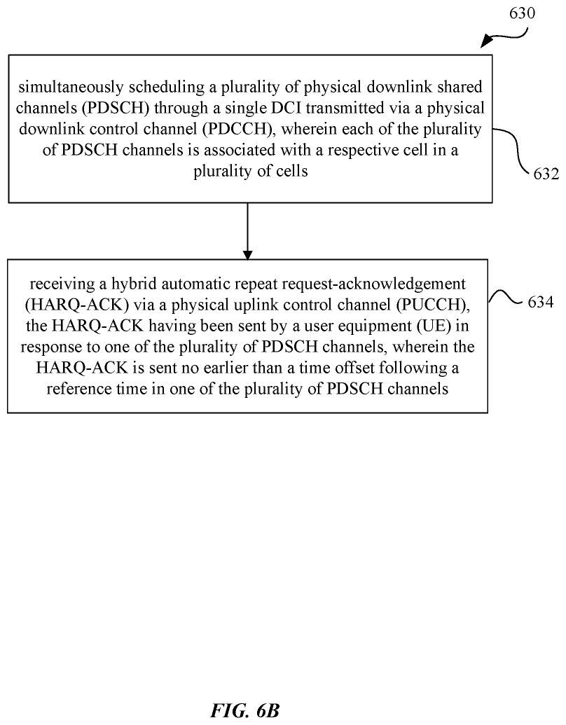

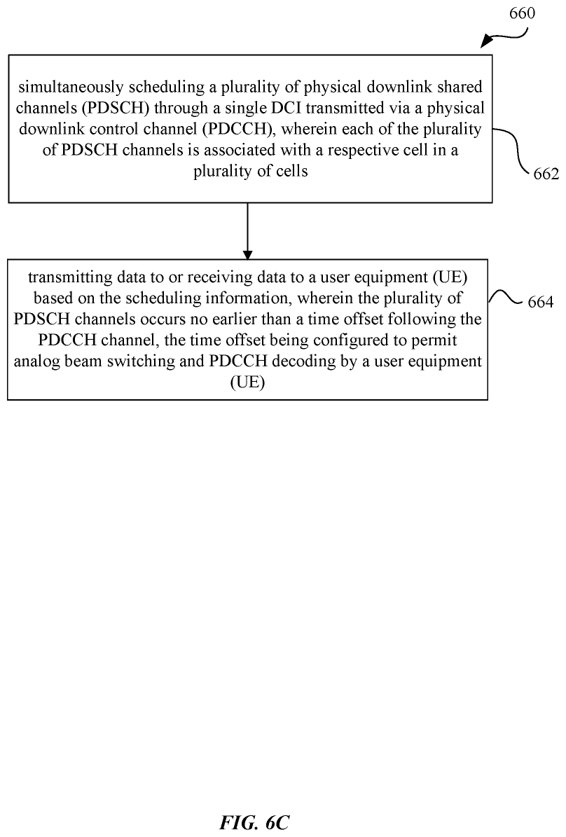

FIG. 6A illustrates a flowchart diagram of a method 600 for simultaneous multi-cell scheduling with a single DCI in a wireless network, in accordance with aspects of the present disclosure. Step 602 includes simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells.

Step 604 includes transmitting data to or receiving data from a user equipment (UE) based on the scheduling information, wherein the plurality of PDSCHs occur no earlier in time than a time offset following the PDCCH.

FIG. 6B illustrates a flowchart diagram of a method 630 for simultaneous multi-cell scheduling with a single DCI in a wireless network, in accordance with aspects of the present disclosure. Step 632 includes simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells.

Step 634 includes, receiving a hybrid automatic repeat request-acknowledgement (HARQ-ACK) via a physical uplink control channel (PUCCH), the HARQ-ACK having been sent by a user equipment (UE) in response to one of the plurality of PDSCHs, wherein the HARQ-ACK is sent no earlier in time than a time offset following a reference time in one of the plurality of PDSCHs.

FIG. 6C illustrates a flowchart diagram of a method 660 for simultaneous multi-cell scheduling with a single DCI in a wireless network, in accordance with aspects of the present disclosure. Step 662 includes simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells.

Step 664 includes, transmitting data to or receiving data from a user equipment (UE) based on the scheduling information, wherein the plurality of PDSCHs occur no earlier in time than a time offset following the PDCCH, the time offset being configured to permit analog beam switching and PDCCH decoding by a user equipment (UE).

### Exemplary Computer System

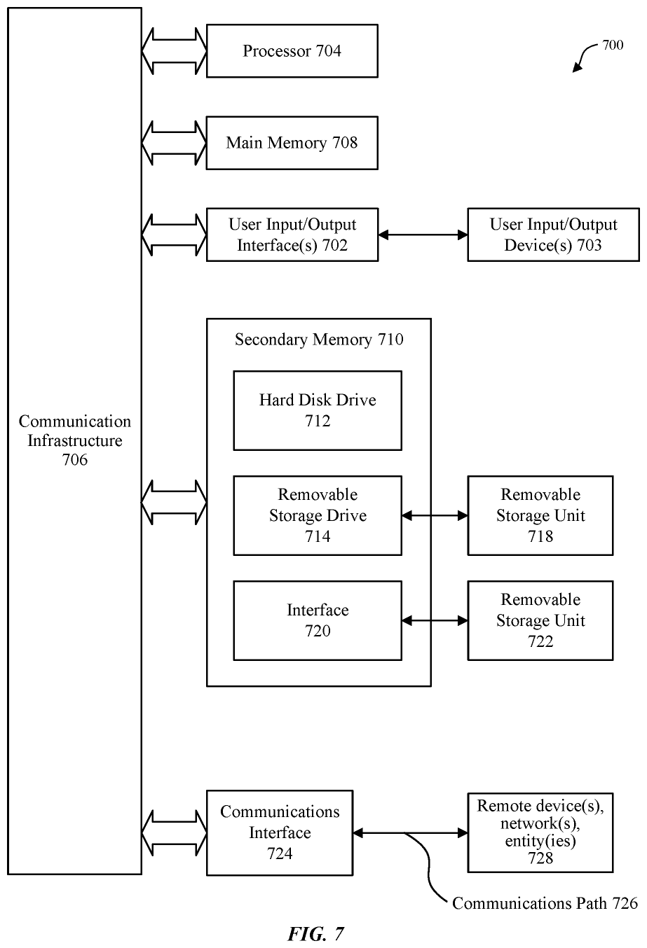

Various aspects can be implemented, for example, using one or more computer systems, such as computer system 700 shown in FIG. 7. Computer system 700 can be any well-known computer capable of performing the functions described herein such as devices 101, 103, 105 of FIG. 1, or 200 of FIG. 2. Computer system 700 includes one or more processors (also called central processing units, or CPUs), such as a processor 704. Processor 704 is connected to a communication infrastructure 706 (e.g., a bus.) Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/ any other computer data storage device. Removable storage drive 714 reads from and/or writes to removable storage unit 718 in a well-known manner.

According to some aspects, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and may include any combination of LANs, WANs, the Internet, etc. Control logic and/or data may be transmitted to and from computer system 700 via communication path 726.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 7. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “an example aspect,” or similar phrases, indicate that the aspect described may include a particular feature, structure, or characteristic, but every aspects may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates aspects in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed aspects, the present disclosure also contemplates that the various aspects can also be implemented without the need for accessing such personal information data. That is, the various aspects of the present technology are not rendered inoperable due to the lack of all or a portion of such personal information data.

What is claimed is:

1. A method for transmitting downlink control information (DCI), the method comprising:
simultaneously scheduling a plurality of physical downlink shared channels (PDSCHs) through a single DCI transmitted via a physical downlink control channel (PDCCH), wherein each of the plurality of PDSCHs is associated with a respective cell in a plurality of cells; and
receiving a hybrid automatic repeat request-acknowledgement (HARQ-ACK) via a physical uplink control channel (PUCCH), the HARQ-ACK having been sent by a user equipment (UE) in response to one of the plurality of PDSCHs , wherein the HARQ-ACK is sent no earlier in time than a time offset following a reference time in one of the plurality of PDSCHs.

2. The method of claim 1, wherein the reference time is a last symbol of one of the plurality of PDSCHs that ends last in time, or a last symbol of one of the plurality of PDSCHs that starts last in time.

3. The method of claim 1, wherein the reference time is a last symbol of one of the plurality of PDSCHs that is a first scheduled PDSCH, or a last symbol of one of the plurality of PDSCHs that is a last scheduled PDSCH.

4. The method of claim 1, wherein the reference time is a last symbol of one of the plurality of PDSCHs that ends earliest in time, or a last symbol of one of the plurality of PDSCHs that starts earliest in time.

5. The method of claim 1, wherein the time offset is determined as a largest N_{1,0} value associated with all of the plurality of PDSCHs, wherein a N_{1,0} value is a PDSCH processing time determined based on an additional demodulation reference signal (DMRS) location for 15 kHz subcarrier spacing (SCS).

6. The method of claim 1, wherein the time offset is determined as a largest N₁ value associated with all of the plurality of PDSCHs, wherein a Ni value is a PDSCH processing time determined based on a UE reported PDSCH processing capability, as a function of a minimum subcarrier spacing (SCS) used for PDSCH, PDCCH and uplink channel that carries a HARQ-ACK.

7. The method of claim 1, wherein the time offset is determined as a largest d_{1,1} value associated with all of the plurality of PDSCHs, wherein a d_{1,1} value is a relaxation of a PDSCH processing time determined based on a number of PDSCH symbols and an overlapping condition between PDSCH and PDCCH.

8. The method of claim 1, wherein the time offset includes an additional time interval, the additional time interval being based on a capability of a UE.

9. The method of claim 8, wherein the additional time interval is based on a value of the SCS.

10. The method of claim 8, wherein the additional time interval is reported by the UE, or is defined in a wireless specification.

11. A base station (B S) in a wireless communication network, the BS comprising:
a radio frequency (RF) transceiver configured to transmit and receive, via at least one antenna; and
processing circuitry coupled to the RF transceiver, the processing circuitry configured to cause the BS to:
simultaneously schedule a plurality of physical downlink shared channels (PDSCHs) through a single DCI transmitted via a physical downlink control channel (PDCCH), wherein each of the plurality of PDSCHs is associated with a respective cell in a plurality of cells; and
receive a hybrid automatic repeat request-acknowledgement (HARQ-ACK) via a physical uplink control channel (PUCCH), the HARQ-ACK having been sent by a user equipment (UE) in response to one of the plurality of PDSCHs, wherein the HARQ-ACK is sent no earlier in time than a time offset following a reference time in one of the plurality of PDSCHs.

12. The BS of claim 11, wherein the reference time is a last symbol of one of the plurality of PDSCHs that ends last in time, or a last symbol of one of the plurality of PDSCHs that starts last in time.

13. The BS of claim 11, wherein the reference time is a last symbol of one of the plurality of PDSCHs that is a first scheduled PDSCH, or a last symbol of one of the plurality of PDSCHs that is a last scheduled PDSCH.

14. The BS of claim 11, wherein the reference time is a last symbol of one of the plurality of PDSCHs that ends earliest, or a last symbol of one of the plurality of PDSCHs that starts earliest.

15. The BS of claim 11, wherein the time offset is determined as a largest N_{1,0} value associated with all of the plurality of PDSCHs, wherein a N_{1,0} value is a PDSCH processing time determined based on an additional demodulation reference signal (DMRS) location for 15 kHz subcarrier spacing (SCS).

16. The BS of claim 11, wherein the time offset is determined as a largest N₁ value associated with all of the plurality of PDSCHs, wherein a N₁ value is a PDSCH processing time determined based on a UE reported PDSCH processing capability, as a function of a minimum subcarrier spacing (SCS) used for PDSCH, PDCCH and uplink channel that carries a HARQ-ACK.

17. The BS of claim 11, wherein the time offset is determined as a largest d_{1,1} value associated with all of the plurality of PDSCHs, wherein a d_{1,1} value is a relaxation of a PDSCH processing time determined based on a number of PDSCH symbols and an overlapping condition between PDSCH and PDCCH.

18. The BS of claim 11, wherein the time offset includes an additional time interval, the additional time interval being based on a capability of a UE.

19. The BS of claim 18, wherein the additional time interval is based on a size of the SCS.

20. The BS of claim 18, wherein the additional time interval is reported by the UE, or is defined in a wireless specification.
